(19) United States
(12) Patent Application Publication
(10) Pub. No.: US 2025/0225579 A1
(43) Pub. Date: Jul. 10, 2025

(54) AUTHENTICATION SYSTEM AND AUTHENTICATION METHOD FOR NFT TRADING PLATFORM

(71) Applicant: CHUNG-HAO HSU, Taipei City (TW)

(72) Inventor: CHUNG-HAO HSU, Taipei City (TW)

(21) Appl. No.: 18/819,779

(22) Filed: Aug. 29, 2024

(30) Foreign Application Priority Data
Jan. 4, 2024 (TW) 113100335

(51) Int. Cl. G06Q 40/04; G06Q 20/36

(52) U.S. Cl. CPC G06Q 40/04; G06Q 20/3674

(57) ABSTRACT

An authentication system for NFT trading platform includes an authentication service account and an authentication server. The authentication service account is provided on a communication server. The authentication service account receives an account identity information and a wallet address transmitted by an electronic device through a user account on the communication server. The authentication server receives the account identity information and the wallet address through the authentication service account. The authentication server generates an authentication password and transmits the authentication password to the user account through the authentication service account. The authentication server determines whether information in a public information field on the NFT trading platform completely matches the authentication password. The authentication server binds the account identity information with the wallet address when the information in the public information field on the NFT trading platform completely matches the authentication password.

### BACKGROUND OF THE INVENTION

### Technical Field

The present invention relates generally to blockchain technology, and more particularly to an authentication system and an authentication method for NFT trading platform.

### Description of Related Art

Blockchain is known to be decentralized, irreversible, full traceability, collectively maintained, and open and transparent. As the blockchain technology evolves, the technology of virtual currencies developed from the blockchain technology is gradually gaining public attention. The virtual currencies mainly include fungible tokens (FT) and non-fungible tokens (NFT). The fungible tokens are tokens that could be interchangeable and divisible, such as Ether (ETH) and Bitcoin (BTC). On the other hand, the non-fungible tokens are tokens that are indivisible and irreplaceable. Currently, the non-fungible tokens are mainly used to link to artwork, such as digital creation.

In general, today's market provides members with permission to purchase or transfer NFTs through trading platforms. For example, OpenSea is currently the largest trading platform for non-fungible tokens (NFTs), covering various types of NFTs, such as crypto collectibles, artworks, gaming assets, virtual lands or domain names, etc. The operation process works as follows: a member of OpenSea links a cryptocurrency wallet to an OpenSea account and logs in to the OpenSea account by logging in to the cryptocurrency wallet, and then the member could purchase, sell, or transfer NFTs with other members. In other words, in order to log in to the OpenSea account to access the information in the NFT trading platform, the member has to log in to the cryptocurrency wallet first; however, to log in to the cryptocurrency wallet, the member needs to enter a password and other personal information, making the operation process complicated and inconvenient. Therefore, how to provide a system or a method for facilitating receiving information transmitted by the NFT trading platform to each account is an urgent issue that needs to be resolved.

### BRIEF SUMMARY OF THE INVENTION

In view of the above, the primary objective of the present invention is to provide an authentication method and an authentication system for NFT trading platform, which could facilitate receiving information transmitted by the NFT trading platform to each account.

The present invention provides an authentication method for NFT trading platform, including steps of:
connecting an electronic device to a communication server;
transmitting, by the electronic device, an account identity information and a wallet address to an authentication service account through a user account, wherein the account identity information corresponds to the user account; the wallet address is for logging in to an NFT trading platform, and the wallet address corresponds to a trading account on the NFT trading platform;
transmitting, by the authentication service account, the account identity information and the wallet address to an authentication server;
generating, by the authentication server, an authentication password;
transmitting, by the authentication server, the authentication password to the authentication service account and transmitting, by the authentication service account, the authentication password to the user account, wherein the authentication password is for filling in a public information field on the NFT trading platform and the public information field corresponds to the trading account;
determining, by the authentication server, whether information in the public information field on the NFT trading platform completely matches the authentication password; and
binding, by the authentication server, the account identity information with the wallet address when the authentication server determines the information in the public information field on the NFT trading platform completely matches the authentication password, so that the authentication server transmits notification information to the authentication service account when the NFT trading platform transmits the notification information to the trading account, and the authentication service account transmits the notification information to the user account.

The present invention further provides an authentication system for NFT trading platform including an authentication service account and an authentication server.

The authentication service account is provided on a communication server, wherein the authentication service account receives an account identity information and a wallet address transmitted by an electronic device through a user account on the communication server when the electronic device is connected to the communication server, and the account identity information corresponds to the user account.

The authentication server is connected to the communication server and an NFT trading platform via a network, wherein the authentication server receives the account identity information and the wallet address through the authentication service account, and the authentication server generates an authentication password and transmits the authentication password to the user account through the authentication service account.

The authentication password is for filling in a public information field on the NFT trading platform, and the public information field corresponds to a trading account. The authentication server determines whether information in the public information field on the NFT trading platform completely matches the authentication password. The authentication server binds the account identity information with the wallet address when the authentication server determines the information in the public information field on the NFT trading platform completely matches the authentication password, so that the authentication server transmits notification information to the authentication service account when the NFT trading platform transmits the notification information to the trading account, and the authentication service account transmits the notification information to the user account.

With the aforementioned design, a user could access the notification information transmitted by the NFT trading platform to the trading account directly in the user account, thereby facilitating the user to receive information transmitted by the NFT trading platform to each account.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of the authentication system for NFT trading platform according to an embodiment of the present invention; and

FIG. 2 is a flow chart of the authentication method for NFT trading platform according to another embodiment of the present invention.

### DETAILED DESCRIPTION OF THE INVENTION

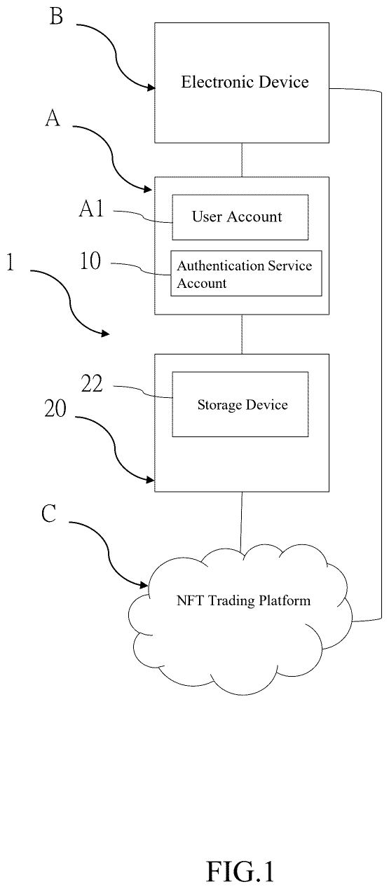

An authentication system 1 for NFT trading platform according to an embodiment of the present invention is shown in FIG. 1. The authentication system 1 includes an authentication service account 10 and an authentication server 20.

The authentication service account 10 is provided on a communication server A. The authentication service account 10 receives an account identity information and a wallet address transmitted by an electronic device B through a user account A1 on the communication server A when the electronic device B is connected to the communication server A. The account identity information corresponds to the user account A1.

In the current embodiment, the authentication service account 10 and the user account A1 are illustrated by accounts of an instant messenger LINE as an example. In other embodiments, the authentication service account 10 and the user account A1 could be accounts of instant messengers, such as Messenger, WeChat, or WhatsApp, or accounts of social network applications, such as Facebook or Instagram. The communication server A could be a server of the instant messenger or the social network application mentioned above.

The electronic device B could be connected to the communication server A via any network, such as 3G, 4G, 5G, Wi-Fi, etc., and the electronic device B could be a device, such as a smartphone, a tablet, a laptop, or a desktop computer. The account identity information could be an account ID of the user account A1.

The authentication server 20 is connected to the communication server A and an NFT trading platform C via a network. The authentication server 20 receives the account identity information and the wallet address through the authentication service account 10. The authentication server 20 generates an authentication password and transmits the authentication password to the user account A1 through the authentication service account 10. As mentioned above, the network could be 3G, 4G, 5G, Wi-Fi, etc., and the NFT trading platform C could be the OpenSea trading platform, for example.

The authentication password is for filling in a public information field on the NFT trading platform C, and the public information field corresponds to a trading account. The authentication server 20 determines whether information in the public information field on the NFT trading platform C completely matches the authentication password. The authentication server 20 binds the account identity information with the wallet address when the authentication server 20 determines that the information in the public information field on the NFT trading platform C completely matches the authentication password, so that the authentication server 20 transmits notification information to the authentication service account 10 when the NFT trading platform C transmits the notification information to the trading account, and the authentication service account 10 transmits the notification information to the user account A1.

The authentication server 20 determines whether the information in the public information field on the NFT trading platform C completely matches the authentication password within a predetermined period, and a mismatch is determined by the authentication server 20 when the predetermined period is exceeded.

The authentication server 20 includes a storage device 22 storing a plurality of authentication records, and each of the plurality of authentication records includes another account identity information and another wallet address.

The authentication server 20 compares the account identity information and the wallet address with the plurality of authentication records. The authentication server 20 transmits a query message to the authentication service account 10 when the account identity information and the wallet address completely match one of the plurality of authentication records, and the authentication service account 10 transmits the query message to the user account A1.

The query message includes information on whether to unbind the account identity information with the wallet address. The user account A1 replies to the query message to transmit an instruction for unbinding the account identity information with the wallet address or retaining the binding between the account identity information and the wallet address.

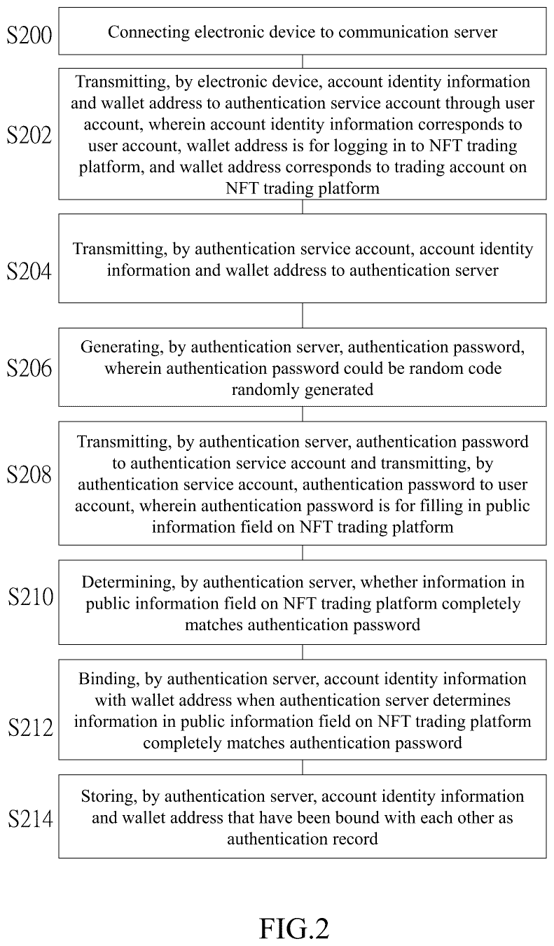

FIG. 2 is a flow chart of an authentication method for NFT trading platform according to another embodiment of the present invention. In the current embodiment, the authentication method is performed using the authentication system 1 mentioned above; in other embodiments, alternative systems could be used to perform the authentication method.

The authentication method includes steps as below.

In step S200, connecting an electronic device B to a communication server A. As mentioned above, the electronic device B could be a device, such as a smartphone, a tablet, a laptop, or a desktop computer; the communication server A could be a server of the instant messenger or the social network application; and the electronic device B could be connected to the communication server A via any network, such as 3G, 4G, 5G, Wi-Fi, etc.

In step S202, transmitting, by the electronic device B, an account identity information and a wallet address to an authentication service account 10 through a user account A1, wherein the account identity information corresponds to the user account A1. The wallet address is for logging in to the NFT trading platform C and the wallet address corresponds to a trading account on the NFT trading platform C. The user account A1 and the authentication service account 10 are provided on a communication server A. When the user account A1 and the authentication service account 10 are friended with each other, a user could transmit the wallet address, which is linked to the NFT trading platform C, and the account identity information to the authentication service account 10 through the user account A1.

In step S204, transmitting, by the authentication service account 10, the account identity information and the wallet address to an authentication server 20. The authentication server 20 stores a plurality of authentication records in the storage device 22, and each of the plurality of authentication records includes another account identity information and another wallet address that have been bound with each other. Step S204 further includes that authentication server 20 compares the account identity information and the wallet address with the plurality of authentication records. When the account identity information and the wallet address completely match one of the plurality of authentication records, that is, when the account identity information and the wallet address are identical to the another account identity information and the another wallet address in one of the plurality of authentication records stored in the storage device 22, the authentication server 20 transmits a query message to the authentication service account 10 and the authentication service account 10 transmits the query message to the user account A1. The query message includes information on whether to unbind the account identity information with the wallet address. The user account A1 replies to the query message to transmit an instruction for unbinding the account identity information with the wallet address or retaining the binding between the account identity information and the wallet address.

When the user account A1 replies to the query message to transmit the instruction for unbinding the account identity information with the wallet address, the authentication service account 10 transmits the instruction for unbinding the account identity information with the wallet address to the authentication server 20. The authentication server 20 unbinds the account identity information with the wallet address and updates the authentication record that is completely identical to the account identity information and the wallet address.

In step S206, generating, by the authentication server 20, an authentication password. The authentication password could be a random code randomly generated.

In step S208, transmitting, by the authentication server 20, the authentication password to the authentication service account 10 and transmitting, by the authentication service account 10, the authentication password to the user account A1. The authentication password is for filling in a public information field on the NFT trading platform C and the public information field corresponds to the trading account. When the authentication server 20 transmits the authentication password to the authentication service account 10, the authentication server 20 could transmit a usage instruction for using the authentication password simultaneously. Then, the authentication service account 10 transmits the usage instruction to the user account A1. The usage instruction could be a tutorial on how to use the authentication password, for example, instructing the user to change the information in the public information field on the NFT trading platform C to the authentication password within a predetermined period after the user accesses the authentication password. The public information field could be a remark field on the NFT trading platform C and the remark field corresponds to personal information of the trading account. The information in the public information field is publicly accessible.

In step S210, determining, by the authentication server 20, whether the information in the public information field on the NFT trading platform C completely matches the authentication password. The authentication server 20 monitors whether the user changes the information in the public information field on the NFT trading platform C to the authentication password within the predetermined period. The authentication server 20 determines whether the information in the public information field on the NFT trading platform C completely matches the authentication password within the predetermined period. A mismatch is determined by the authentication server 20 when the predetermined period is exceeded.

In step S212, binding, by the authentication server 20, the account identity information with the wallet address when the authentication server 20 determines the information in the public information field on the NFT trading platform C completely matches the authentication password, so that the authentication server 20 transmits notification information to the authentication service account 10 when the NFT trading platform C transmits the notification information to the trading account, and the authentication service account 10 transmits the notification information to the user account A1. To further illustrate, the authentication server 20 transmits a warning message to the authentication service account 10 when the authentication server 20 recognizes the information in the public information field and determines that the information in the public information field does not match the authentication password, and the authentication service account 10 transmits the warning message to the user account A1 to notify the user of the binding failure.

In step S214, storing, by the authentication server 20, the account identity information and the wallet address that have been bound with each other as an authentication record. In step S214, the authentication server 20 further transmits a completion message to the authentication service account 10, and the authentication service account 10 transmits the completion message to the user account A1 to notify the user of the binding completed.

With the aforementioned design, the user could access the notification information transmitted by the NFT trading platform C to the trading account directly in the instant messenger, thereby facilitating the user to receive information transmitted by the NFT trading platform C to each account.

It must be pointed out that the embodiments described above are only some preferred embodiments of the present invention. All equivalent structures which employ the concepts disclosed in this specification and the appended claims should fall within the scope of the present invention.

What is claimed is:

1. An authentication method for NFT trading platform, comprising steps of:
connecting an electronic device to a communication server;
transmitting, by the electronic device, an account identity information and a wallet address to an authentication service account through a user account, wherein the account identity information corresponds to the user account; the wallet address is for logging in to an NFT trading platform and the wallet address corresponds to a trading account on the NFT trading platform;
transmitting, by the authentication service account, the account identity information and the wallet address to an authentication server;
generating, by the authentication server, an authentication password;
transmitting, by the authentication server, the authentication password to the authentication service account and transmitting, by the authentication service account, the authentication password to the user account, wherein the authentication password is for filling in a public information field on the NFT trading platform and the public information field corresponds to the trading account;
determining, by the authentication server, whether information in the public information field on the NFT trading platform completely matches the authentication password; and
binding, by the authentication server, the account identity information with the wallet address when the authentication server determines the information in the public information field on the NFT trading platform completely matches the authentication password, so that the authentication server transmits notification information to the authentication service account when the NFT trading platform transmits the notification information to the trading account, and the authentication service account transmits the notification information to the user account.

2. The authentication method for NFT trading platform as claimed in claim 1, wherein the authentication server determines whether the information in the public information field on the NFT trading platform completely matches the authentication password within a predetermined period; a mismatch is determined by the authentication server when the predetermined period is exceeded.

3. The authentication method for NFT trading platform as claimed in claim 1, comprising storing, by the authentication server, the account identity information and the wallet address that have been bound with each other as an authentication record, wherein the authentication server stores a plurality of another authentication records, and each of the plurality of another authentication records includes another account identity information and another wallet address that have been bound with each other.

4. The authentication method for NFT trading platform as claimed in claim 3, comprising comparing, by the authentication server, the account identity information and the wallet address with the plurality of another authentication records, wherein the authentication server transmits a query message to the authentication service account when the account identity information and the wallet address completely match one of the plurality of another authentication records, and the authentication service account transmits the query message to the user account.

5. The authentication method for NFT trading platform as claimed in claim 4, wherein the query message includes information on whether to unbind the account identity information with the wallet address, and the user account replies to the query message to transmit an instruction for unbinding the account identity information with the wallet address or retaining the binding between the account identity information and the wallet address.

6. An authentication system for NFT trading platform, comprising:
an authentication service account provided on a communication server, wherein the authentication service account receives an account identity information and a wallet address transmitted by an electronic device through a user account on the communication server when the electronic device is connected to the communication server, and the account identity information corresponds to the user account; and
an authentication server connected to the communication server and an NFT trading platform via a network, wherein the authentication server receives the account identity information and the wallet address through the authentication service account, and the authentication server generates an authentication password and transmits the authentication password to the user account through the authentication service account;
wherein the authentication password is for filling in a public information field on the NFT trading platform and the public information field corresponds to a trading account; the authentication server determines whether information in the public information field on the NFT trading platform completely matches the authentication password; the authentication server binds the account identity information with the wallet address when the authentication server determines the information in the public information field on the NFT trading platform completely matches the authentication password, so that the authentication server transmits notification information to the authentication service account when the NFT trading platform transmits the notification information to the trading account, and the authentication service account transmits the notification information to the user account.

7. The authentication system for NFT trading platform as claimed in claim 6, wherein the authentication server determines whether the information in the public information field on the NFT trading platform completely matches the authentication password within a predetermined period, and a mismatch is determined by the authentication server when the predetermined period is exceeded.

8. The authentication system for NFT trading platform as claimed in claim 7, wherein the authentication server includes a storage device storing a plurality of authentication records, and each of the plurality of authentication records includes another account identity information and another wallet address.

9. The authentication system for NFT trading platform as claimed in claim 8, wherein the authentication server compares the account identity information and the wallet address with the plurality of authentication records; the authentication server transmits a query message to the authentication service account when the account identity information and the wallet address completely match one of the plurality of authentication records, and the authentication service account transmits the query message to the user account.

10. The authentication system for NFT trading platform as claimed in claim 9, wherein the query message includes information on whether to unbind the account identity information with the wallet address, and the user account replies to the query message to transmit an instruction for unbinding the account identity information with the wallet address or retaining the binding between the account identity information and the wallet address.
